(19) United States
(12) Patent Application Publication
(10) Pub. No.: US 2024/0020710 A1
(43) Pub. Date: Jan. 18, 2024

(54) SEARCH ORDER AND RATE DETERMINATION IN ATTRIBUTE-BASED ENVIRONMENTS

(71) Applicant: INTERNATIONAL BUSINESS MACHINES CORPORATION, ARMONK, NY (US)

(72) Inventors: Markus Ettl, Yorktown Heights, NY (US); Shivaram Subramanian, Frisco, TX (US); Wei Sun, Scarsdale, NY (US); Mengzhenyu Zhang, Ann Arbor, MI (US)

(21) Appl. No.: 17/812,449

(22) Filed: Jul. 14, 2022

(51) Int. Cl. G06Q 30/02; G06N 20/00; G06K 9/62; G06F 16/28

(52) U.S. Cl. CPC G06Q 30/0201; G06N 20/00; G06K 9/6215; G06F 16/285

(57) ABSTRACT

A processor may receive input data. The processor may train based on the received input data, a machine learning model to estimate rate elasticity, attraction value, and a dissimilarity index associated with an object query and at least one object attribute. The processor may generate one or more object bundles. The processor may output the one or more object bundles to the user.

### BACKGROUND

The present disclosure relates generally to the field of online booking, and more specifically to automatically determining search order and rate in attribute-based environments based on a user booking query.

Attribute-Based Shopping (ABS) is a new era of retailing in the travel industry. ABS allows users to procure exactly the type of product/object that they want for a memorable travel experience. In the hospitality/travel industry, ABS often entails the “unbundling” of room rates and room attributes (e.g., “balcony”, “ocean-view”, “breakfast”, “club access”, etc.); ABS allows users to select, bundle, and pay for only the attributes that they select.

However, currently, the rate structuring in the hospitality/travel industry is to provide pre-determined bundles of room and services. Accordingly, hotels and other venues need to maintain thousands of bundled rate records, which are typically static add-ons to a reference rate from a revenue management (RM) system. Users can only choose from these limited options, instead of having the flexibility of selecting property attributes and room features that are pertinent for their stay and be able to pay for precisely what they request. Further, the number of feasible bundles is exponential in terms of attributes, that is, with K attributes, there are 2 K (or 2\hat{ }K) possible bundles. Hence, most existing bundle rate methodologies suffer computational challenges arising from the issue of high dimensionality.

### SUMMARY

Embodiments of the present disclosure include a method, computer program product, and system for determining search order and rate in an attribute-based environment. A processor may receive input data. The input data may include, at least, an object query and object information. The object query may be generated by a user. The object information may include, at least, one leading object and at least one object attribute together with a rate range. The processor may train, based on the received input data, a machine learning model to estimate rate elasticities, attraction values, and dissimilarity indices associated with the object query and the at least one object attribute. The processor may generate one or more object bundles. The one or more object bundles may include the one leading object and one or more other object attributes associated with the leading product. The one or more object attributes may include the at least one object attribute. The processor may output the one or more object bundles to the user. The one or more object bundles may include respective optimized rates based on the one or more object attributes.

In some embodiments, the processor may receive prior user data. The prior user data may include, at least a unique identifier for a prior user, procurement information that may include time series data associated with the procurement of the leading object together with the one or more object attributes.

In some embodiments, the processor may generate, based on the object query and the machine learning model, an attribute rate model. The attribute rate model may indicate respective rates for the one or more object attributes.

In some embodiments, the attribute rate model may capture dependencies across the one or more object attributes using one or more of a nested decision tree structure, rate elasticities, attraction values, and dissimilarity indices and, in some embodiments, the processor may refine the attribute rate model by utilizing an algorithm based on a refined fixed-point iteration method with designed interation step.

In some embodiments, may generate, based on the machine learning model and the attribute rate model, one or more procurement predictions. The one or more procurement models may be respectively associated with the one or more object bundles.

In some embodiments, the processor may prioritize the one or more object bundles based on a predicted procurement propensity by the user.

In some embodiments, the machine learning model may include a nested logit estimation model.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A illustrates a block diagram of a current booking flow process, in accordance with aspects of the present disclosure.

FIG. 1B illustrates a block diagram of a new booking flow process, in accordance with aspects of the present disclosure.

FIG. 1C illustrates a block diagram of an example system for determining search order and rate in an attribute-based environment, in accordance with aspects of the present disclosure.

FIG. 1D illustrates a block diagram of an example nested logit model for determining search order and rate in an attribute-based environment, in accordance with aspects of the present disclosure.

FIG. 2 illustrates a flowchart of an example method for determining search order and rate in an attribute-based environment, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of online booking, and more specifically to automatically determining search order and rate in attribute-based environments based on a user booking query. While the present disclosure is not necessarily limited to such applications, various aspects of the disclosure may be appreciated through a discussion of various examples using this context.

Attribute-Based Shopping (ABS) is the new era of retailing in the hospitality/travel industry. ABS allows users to purchase exactly the type of product they want for a memorable travel. In the hospitality industry, ABS often entails the “unbundling” of room rates and room attributes (e.g., “balcony”, “ocean-view”, “breakfast”, “club access”, etc.). Accordingly, ABS is an excellent way to generate additional revenues for a property, as users are generally willing to pay for certain optional services based on the context of their trip, and the attributes/services make a property seem like a better choice overall.

However, there are two fundamental challenges with ABS; there is: 1) no attribute-based pricing considering the dependencies among bundles with shared or conflicting attributes and 2) no optimization of packages (bundles) and search order. Accordingly, disclosed herein is a solution that addresses those two fundamental challenges. For example, for attribute-based pricing, the proposed solution determines an optimized price attached to each room attribute based on the user (e.g., business traveler, vacationer, etc.), or customer segment, travel context, and/or inventory conditions, etc. In another example, for optimizing packages and search order, the proposed solution provides users with what they're really looking for when shopping on a hotel web site; the proposed solution determines the user's intent and matches the intent to relevant combinations of room and room attributes, and finds an optimized sort order.

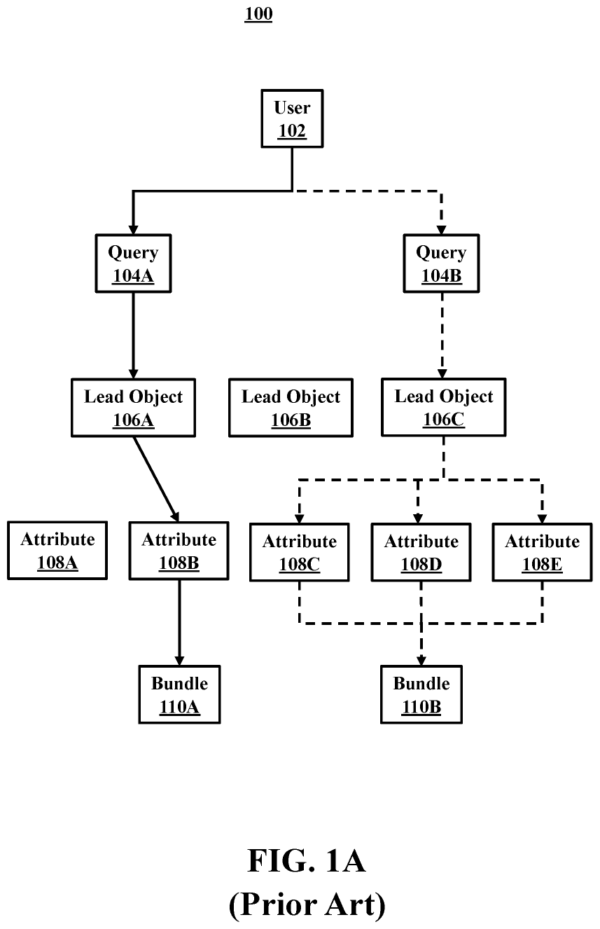

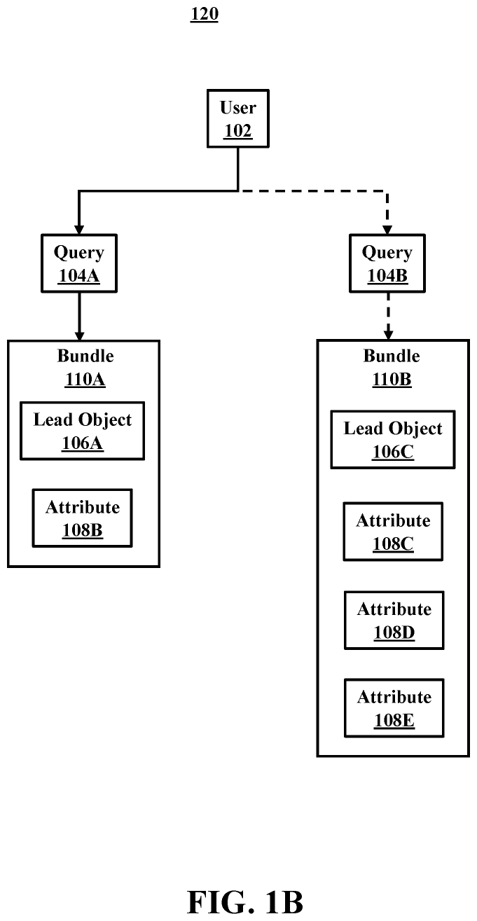

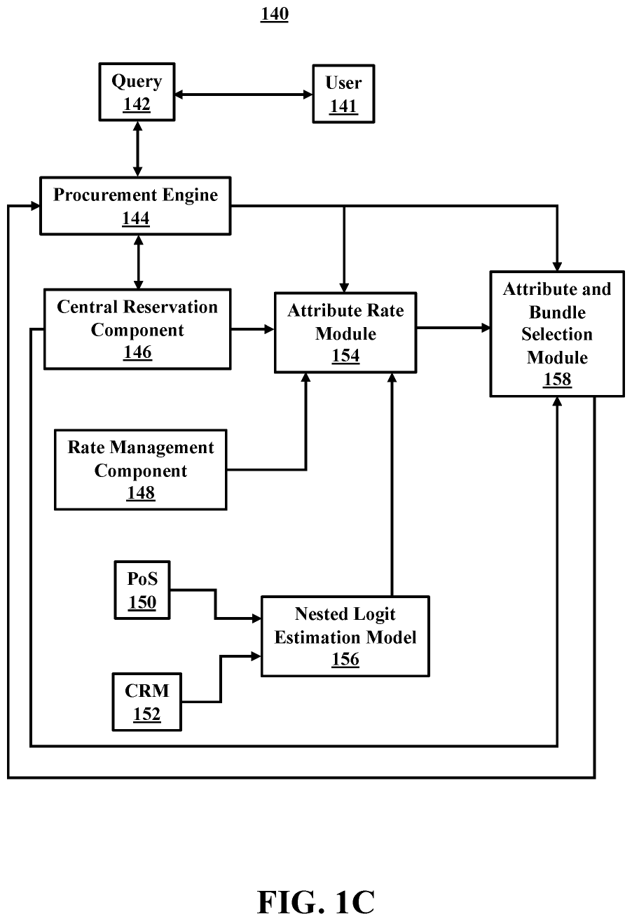

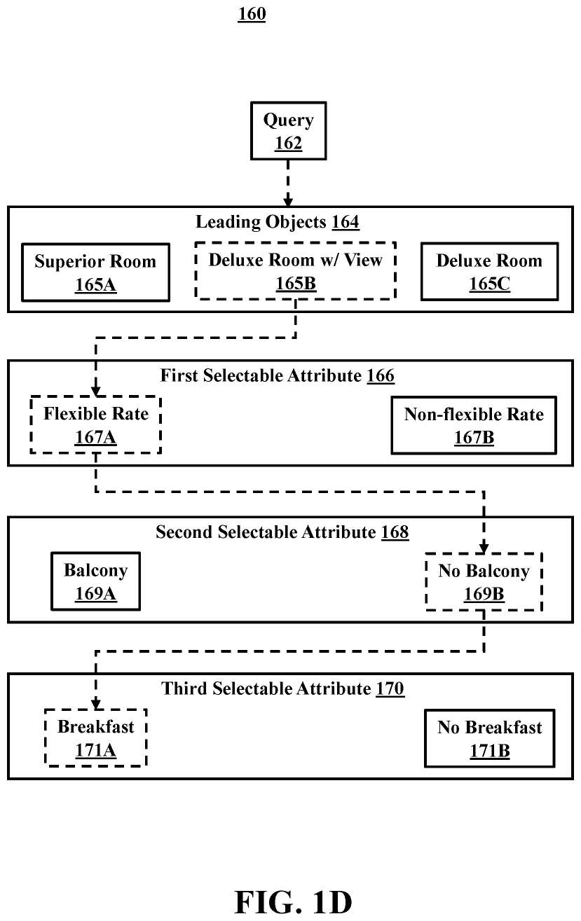

Referring now to FIG. 1A, illustrated is a block diagram of a current booking flow process 100, in accordance with aspects of the present disclosure. As depicted, the current booking flow process 100 includes a user 102, queries 104A-B, lead objects 106A-C, attributes 108A-E, and bundles 110A-B.

As depicted, the user 102 may provide query 104A, which may be a booking query for a business trip that lasts from Tuesday to Thursday, and the user 102 may provide query 104B, which may be a booking query for a personal vacation that lasts from Friday to Monday. The current booking flow process 100 may identify in both instances that a lead object (sometimes referred to as a lead product) is a hotel room. The current booking flow process 100 may allow the user 102, in regard to both queries 104A-B to select from lead objects 106A-C the lead object (e.g., room they prefer for which query). Further, the current booking flow process 100 may allow the user 102 to select which attributes 108A-E they prefer. The selected lead object and attributes are then presented as the bundles 110A-B.

For instance, the user 102, for query 104A, may select an interior room as lead object 106A and a breakfast as attribute 108B; the user 102's selection of lead object 106A and attribute 108B would then be bundle 110A. In another instance, the user 102, for query 104B, may select an ocean view room as lead object 106C and a dinner, day spa voucher, and excursion voucher as attributes 108C-E; the user 102's selection of lead object 106C and attributes 108C-E would then be bundle 110B. Regardless of the bundle 110A or 110B, the user is only selecting attributes (e.g., add-ons) for bundles that have already been set and already have previously predetermined rates/prices.

Referring now to FIG. 1B, illustrated is a block diagram of a new booking flow process 120, in accordance with aspects of the present disclosure. As depicted, the new booking flow process 120 includes the user 102, queries 104A-B, and bundles 110A-B with lead objects 106A and 106C, and attributes 108B-E. In some embodiments the user 102, queries 104A-B, lead objects 106A and 106C, attributes 108B-E, and bundles 110A-B may be the same as, or substantially similar to the user, queries, lead objects, attributes, and bundles as described in FIG. 1A.

However, different than the current booking flow process 100 in FIG. 1A, the new booking flow process 120 prioritize attributes and bundles that may dynamically vary based on customer segment and inventory conditions and determines individual attribute rates (e.g., prices) that optimize a business objective (e.g., increase user satisfaction, decreased room vacancies, etc.). Overall, the new booking flow process 120 simplifies and provides differentiation to the current rigid pricing structure as provided in the current booking flow process 100 and provides greater flexibility of managing inventory (e.g., rooms and availability for activities/attributes/etc.).

As an example, assume as before in regard to FIG. 1A that the user 102 provides query 104A, which may be a booking query for a business trip that lasts from Tuesday to Thursday, and the user 102 may provide query 104B, which may be a booking query for a personal vacation that lasts from Friday to Monday. The new booking flow process 120 identifies that the query 104A is in the middle of the week and likely a business trip, accordingly, the new booking flow process 120 generates bundle 110A, which displays a prioritized room (e.g., interior/quiet room) as lead object 106A with prioritized add-ons (e.g., a breakfast voucher) as attribute 108B. Further, the new booking flow process 120 identifies that the query 104B is in through the weekend and likely a vacation trip, accordingly, the new booking flow process 120 generates bundle 110B, which displays a prioritized room (e.g., ocean view room) as lead object 106C with prioritized add-ons (e.g., a dinner voucher, a spa voucher, and an excursion voucher) as attributes 108C-E.

The new booking flow process 120 accordingly displays a dynamically generated bundle to the user 102 based on the likely intent of the user 102's reason for a query (e.g., business, vacation, etc.) and the new booking flow process 120 provides the best selections (e.g. rooms and add-ons as the bundles) to the user 102 (e.g., the user 102 does not see lead object 106B as it's a lower floor room and loud, and the user does not see attribute 108A as it's a tour deal for 8 or more persons, etc.). Further, the new booking flow process 120 can generate bundles that have not already been generated and which have a static rate associated with them, as is the case with the current booking flow process 100.

In some embodiments, if the user 102 does not like a bundle, the user may select to have the new booking flow process 120 generate a new bundle or perform manual input as provided by the current booking flow process 120.

Referring now to FIG. 1C, illustrated is a block diagram of an example system 140 for determining search order and rate in an attribute-based environment, in accordance with aspects of the present disclosure. As depicted, the system 140 includes a user 141, a query 142, a procurement engine 144, a central reservation component 146, a rate management component 148, a point of sales (PoS) 150 system, a customer relationship management (CRM) 152 system/software, an attribute rate module 154, a nested logit estimation model 156, and an attribute and bundle selection module 158. In some embodiments, the user 141 and the query 142 may be the user or queries discussed in regard to FIGS. 1A and 1B.

As depicted, the user 141 generates and submits the query 142 to the system 140. The query 142 is then received by the procurement engine 144 (which may be a website booking engine). The procurement engine 144 then relays information associated with the query (e.g., travel context such as length of stay, if the stay is on a weekend/weekday, number in party, etc.) to the central reservation component 146, the attribute rate module 154, and the attribute and bundle selection module 158.

In some embodiments, the central reservation component 146 then provides the number of available product attributes (e.g., add-ons) and rate (e.g., price) constraints for/on the attributes to the attribute rate module 154 and the attribute and bundle selection module 158. In some embodiments, the rate management component 148 (which may be a revenue management [RM] system) provides a base rate (e.g., for the leading object/product/room/etc. and/or the attributes) to the attribute rate module 154.

In some embodiments, the PoS 150 provides user purchase history or histories to the nested logit estimation model 156. Further, the CRM 152 provides customer segments, such as loyalty level of the user, to the nested logit estimation model 156. In some embodiments, the nested logit estimation model 156 relays the information provided from the PoS 150 and the CRM 152 to the attribute rate module 154.

In some embodiments, the attribute rate module 154 optimizes the rates for the available attributes (as provided by the central reservation component 146) and generates a purchase probability for different bundles (e.g., the leading object with various attributes). In some embodiments, the attribute rate module 154 further provides and/or generates user price elasticities, similarity scores (e.g., a prior/previous user purchased this room with such and such add-ons, so likely this user will too, etc.), and/or attribute attraction values (e.g., how likely a user is to purchase said attribute). In some embodiments, the optimized rates and the probability are then relayed to the attribute and bundle selection module 158.

In some embodiments, the attribute and bundle selection module 158 analyzes all the information it has received and then generates recommended attributes and attribute rates to be displayed in a prioritized sort order to the user (e.g., bundle one includes a balcony room with a family excursion, bundle two includes no balcony and includes breakfast, etc.). It is noted that the current process for bundling does not allow for the real-time, dynamic generation of bundles as is provided by the attribute and bundle selection module 158; the current process only includes bundles that are premade with predetermined rates or use predetermined rates for attributes.

In some embodiments, the attribute and bundle selection module 158 relays the recommendations in the prioritized order to the procurement engine 144, which further relays the recommendation to the user 141.

It is further noted that the system 140 includes components not used by any other type of management system that involves bookings. The attribute rate module 154, nested logit estimation model 156, and attribute and bundle selection module 158 are components specifically incepted for this present disclosure.

Referring now to FIG. 1D, illustrated is a block diagram of an example nested logit model 160 for determining search order and rate in an attribute-based environment, in accordance with aspects of the present disclosure. As depicted, the nested logit model 160 includes query 162; leading objects 164, which include superior room 165A, deluxe room with a view 165B, and deluxe room 165C; first selectable attributes 166, which include flexible rate 167A and non-flexible rate 167B; second selectable attribute 168, which include balcony 169A and no balcony 169B; and third selectable attribute 170, which include breakfast 171A and no breakfast 171B. In some embodiments, the query 162 may be the same as, or substantially similar to, the queries discussed in regard to the other FIGS.

As an example, the query 162 is ingested by the nested logit model 160 and is analyzed. The nested logit model 160 then determines, based on the query 162, that the best attribute rates of the leading objects 164, the first selectable attribute 166, the second selectable attribute 168 and the third selectable attribute 170. The nested logit model 160 further generates the best leading object 164 is the deluxe room with a view 165B. The nested logit model 160 further determines, based on the query 162 and the selected leading object 164, that the best first selectable attribute 166 is the flexible rate 167A. The nested logit model 160 further determines, based on the query 162, the selected leading object 164, and the first selectable attribute 166, that the best second selectable attribute 168 is no balcony 169B. Lastly, the nested logit model 160 further determines, based on the query 162, the selected leading object 164, the first selectable attribute 166, and the second selectable attribute 168, that the best third selectable attribute 170 is breakfast 171A. Accordingly, the nested logit model 160 would then provide the selection with the rates (e.g., a bundle of a deluxe room with a view 165C with a flexible rate 167A, no balcony 169B, and breakfast 171A) to a user who provided the query 162.

As a more in-depth description of the nested logit model 160 of FIG. 1D, it is noted that to model the dependence across attributes which results in strong correlation among bundles, a d-level nested logit model is used, where each level represents an attribute, and each leaf node represents a bundle which is made up of different combination of attributes. For such a model to be used, it is assumed that the rate/price of a bundle is the sum of its attribute rates. Once the d-level nested logit model (160) is estimated, purchase probability for each bundle given the attribute prices can be evaluated. Next, an optimization problem is formulated to maximize the expected revenue from selling bundles by optimizing individual attribute rates. Thus, instead of optimizing 2k bundle prices as in the standard bundle pricing literature, the optimization problem only has K individual attribute prices as decision variables. Further, instead of estimating a joint valuation distribution which becomes computationally challenging when K is large, there are standard methods to estimate the parameters (α, β, τ) in a d-level nested logit model.

As an example, assume a user sells U products indexed by {1, 2, . . . , U} to arriving users. A no-purchase option is labelled as product/leading object “0”. Each product is associated with subsets of K attributes indexed by {1, 2, . . . , K}. To generate the nested logit model 160, the arriving users' choices are modeled and processed by a (K+2)-level binary tree G=(V, E), where V is the set of vertices and E is the set of edges. Each level of the tree is indexed by {0, 1, 2, . . . , K, K+1}.

In such an embodiment, the root node lies at level “0” and a node representing the no-purchase option lies in level “1” as an alternative to starting to assemble a final product by selecting the base option. In the hotel setting, the base option refers to a standard room without extra amenities.

Continuing, the branches of nodes in level k ∈ {1, 2, . . . , K} represent choosing (if available) the k-th attribute or not. Further, child(i): the set of child nodes of node i is defined, i.e., child(i) is the set of nodes directly connected to node i in the next level; parent(j) is defined: i.e., the parent node of node j E V \ root, which is the node directly connected to node j in the previous level of node j; and leaf node is defined: i.e., the set of nodes in V with no children, excluding the node in level 1 associated with the no-purchase option. The leaf nodes in leaf represent the final products offered to the customer (e.g., the bundles).

Additionally, the price of attribute K is defined as r_{K}. The attribute price vector is r=(r₀ r₁ r₂ . . . r_{K})^{T}. Also, for j ∈ leaf and k=0, 1, 2, . . . , K,bⱼₖ ∈ {0, 1} indicates whether attribute K is chosen in product j. Vector bⱼ=(bⱼ₀ bⱼ₁ . . . b_{jK})^{T} ∈ {0, 1}K+1 encodes the path from root to leaf node j in terms of which edges (i.e., attributes) are selected. The rate associated with each edge is bⱼₖ rₖ. The price of the final product associated with leaf j is pⱼ:=bⱼ^{T} r.

It is noted that with the proposed booking flow process disclosed herein is on average ten (10) times faster than with the current booking flow process that is used presently.

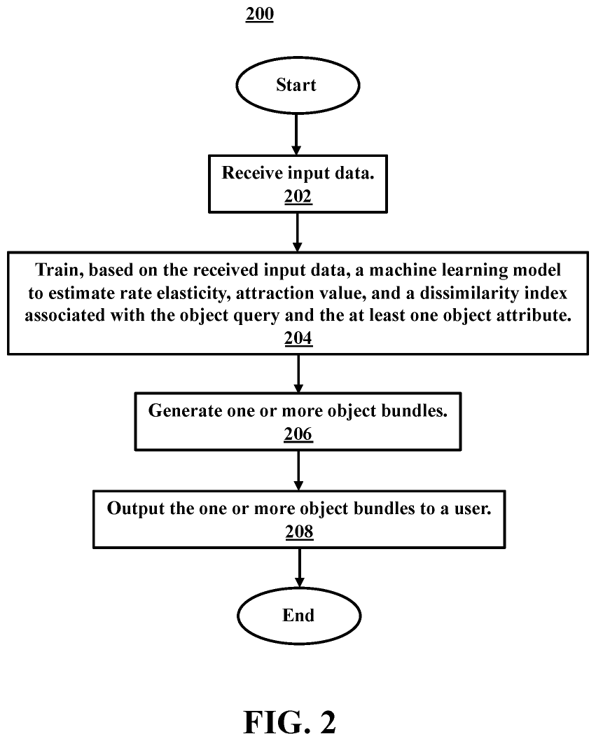

Referring now to FIG. 2, illustrated is a flowchart of an example method for determining search order and rate in an attribute-based environment, in accordance with aspects of the present disclosure. In some embodiments, the method 200 may be performed by a processor (e.g., of the system 140 of FIG. 1C, etc.).

In some embodiments, the method 200 begins at operation 202, where the processor receives input data. The input data may include, at least, an object query and object information. The object query may be generated by a user. The object information may include, at least, one leading object and at least one object attribute together with a rate range.

In some embodiments, the method 200 proceeds to operation 204, where the processor trains, based on the received input data, a machine learning model to estimate rate elasticities, attraction values, and dissimilarity indices associated with the object query and the at least one object attribute.

In some embodiments, the method 200 proceeds to operation 206, where the processor generates one or more object bundles. The one or more object bundles may include the one leading object and one or more other object attributes associated with the leading product. The one or more object attributes may include the at least one object attribute.

In some embodiments, the method 200 proceeds to operation 208, where the processor outputs the one or more object bundles to the user. The one or more object bundles may include respective optimized rates based on the one or more object attributes. In some embodiments, the method 200 may end.

In some embodiments, discussed below, there are one or more operations of the method 200 not depicted for the sake of brevity and which are discussed throughout this disclosure. Accordingly, in some embodiments, the processor may receive prior user data. The prior user data may include, at least a unique identifier for a prior user, procurement information that may include time series data associated with the procurement of the leading object together with the one or more object attributes.

In some embodiments, the processor may generate, based on the object query and the machine learning model, an attribute rate model. The attribute rate model may indicate respective rates for the one or more object attributes.

In some embodiments, the attribute rate model may capture dependencies across the one or more object attributes using one or more of rate elasticity, attraction value, and a dissimilarity index and, in some embodiments, the processor may refine the attribute rate model by utilizing a fixed-point iteration.

In some embodiments, may generate, based on the machine learning model and the attribute rate model, one or more procurement predictions. The one or more procurement models may be respectively associated with the one or more object bundles.

In some embodiments, the processor may prioritize the one or more object bundles based on a predicted procurement propensity by the user.

In some embodiments, the machine learning model may include a nested logit estimation model.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

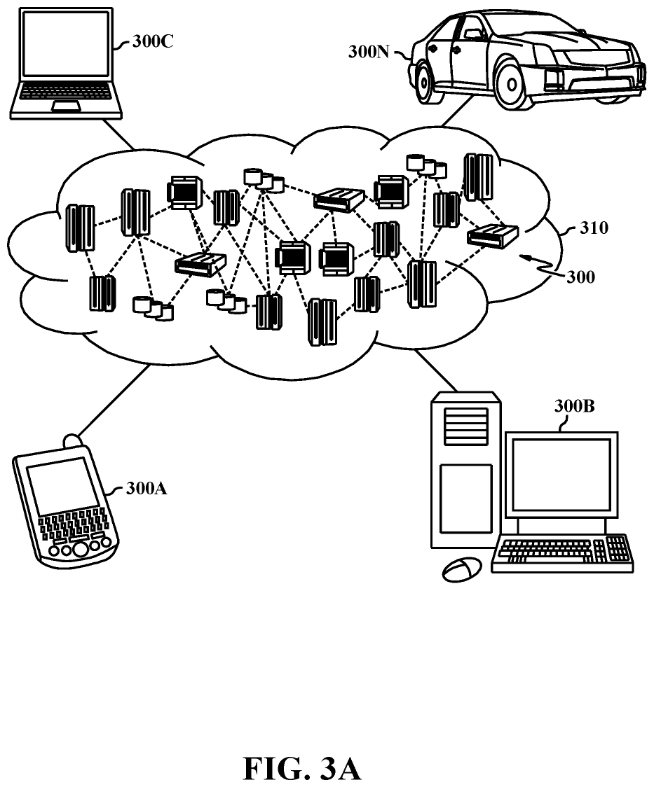

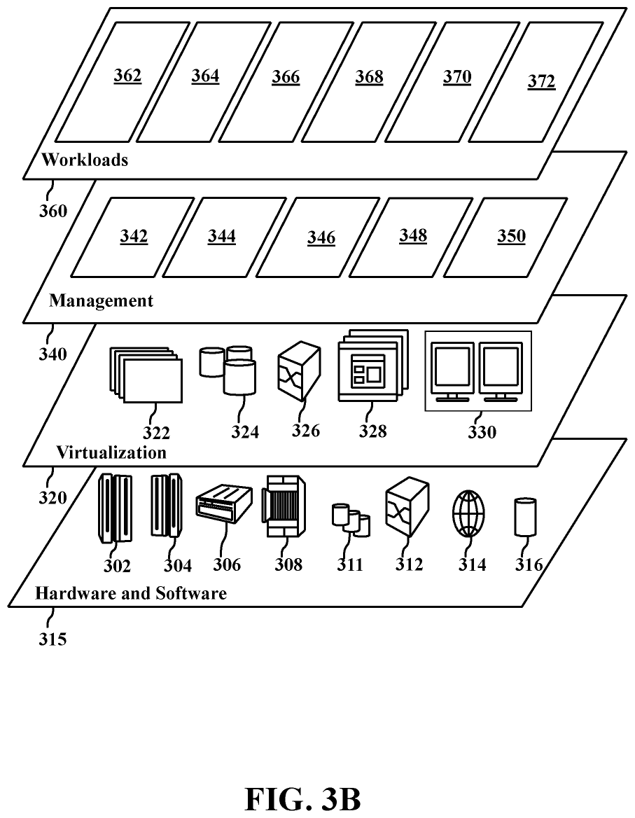

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and search order and rate determination 372.

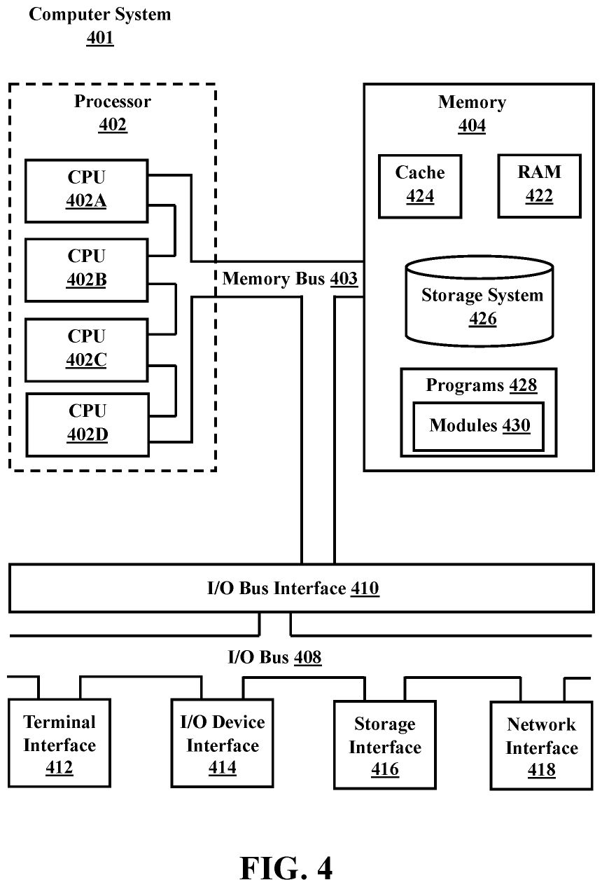

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system for determining search order and rate in an attribute-based environment, the system comprising:
a memory; and
a processor in communication with the memory, the processor being configured to perform operations comprising:
receiving input data, wherein the input data includes, at least, an object query and object information, wherein the object query is generated by a user, and wherein the object information includes, at least, one leading object and at least one object attribute together with a rate range;
training, based on the received input data, a machine learning model to estimate rate elasticity, attraction value, and a dissimilarity index associated with the object query and the at least one object attribute;
generating one or more object bundles, wherein the one or more object bundles include the one leading object and one or more other object attributes associated with the leading product, and wherein the one or more object attributes include the at least one object attribute; and
outputting the one or more object bundles to the user, wherein the one or more object bundles include respective optimized rates based on the one or more object attributes.

2. The system of claim 1, wherein the processor is further configured to perform operations comprising:
receiving prior user data, wherein the prior user data includes, at least a unique identifier for a prior user, procurement information that includes time series data associated with the procurement of the leading object together with the one or more object attributes.

3. The system of claim 2, wherein the processor is further configured to perform operations comprising:
generating, based on the object query and the machine learning model, an attribute rate model, wherein the attribute rate model indicates respective rates for the one or more object attributes.

4. The system of claim 3, wherein the attribute rate model captures dependencies across the one or more object attributes using one or more of rate elasticity, attraction value, and a dissimilarity index, and wherein the processor is further configured to perform operations comprising:
refining the attribute rate model by utilizing a fixed-point iteration.

5. The system of claim 4, wherein the processor is further configured to perform operations comprising:
generating, based on the machine learning model and the attribute rate model, one or more procurement predictions, wherein the one or more procurement models are respectively associated with the one or more object bundles.

6. The system of claim 5, wherein the processor is further configured to perform operations comprising:
prioritizing the one or more object bundles based on a predicted procurement propensity by the user.

7. The system of claim 1, wherein the machine learning model includes a nested logit estimation model.

8. A computer-implemented method for determining search order and rate in an attribute-based environment, the method comprising:
receiving input data, wherein the input data includes, at least, an object query and object information, wherein the object query is generated by a user, and wherein the object information includes, at least, one leading object and at least one object attribute together with a rate range;
training, based on the received input data, a machine learning model to estimate rate elasticity, attraction value, and a dissimilarity index associated with the object query and the at least one object attribute;
generating one or more object bundles, wherein the one or more object bundles include the one leading object and one or more other object attributes associated with the leading product, and wherein the one or more object attributes include the at least one object attribute; and
outputting the one or more object bundles to the user, wherein the one or more object bundles include respective optimized rates based on the one or more object attributes.

9. The computer-implemented method of claim 8, further comprising:
receiving prior user data, wherein the prior user data includes, at least a unique identifier for a prior user, procurement information that includes time series data associated with the procurement of the leading object together with the one or more object attributes.

10. The computer-implemented method of claim 9, further comprising:
generating, based on the object query and the machine learning model, an attribute rate model, wherein the attribute rate model indicates respective rates for the one or more object attributes.

11. The computer-implemented method of claim 10, wherein the attribute rate model captures dependencies across the one or more object attributes using one or more of rate elasticity, attraction value, and a dissimilarity index, and wherein the method further comprises:
refining the attribute rate model by utilizing a fixed-point iteration.

12. The computer-implemented method of claim 11, further comprising:
generating, based on the machine learning model and the attribute rate model, one or more procurement predictions, wherein the one or more procurement models are respectively associated with the one or more object bundles.

13. The computer-implemented method of claim 12, further comprising:
prioritizing the one or more object bundles based on a predicted procurement propensity by the user.

14. The computer-implemented method of claim 8, wherein the machine learning model includes a nested logit estimation model.

15. A computer program product for determining search order and rate in an attribute-based environment comprising a computer readable storage medium having program instructions embodied therewith, the program instructions executable by a processor to cause the processor to perform operations, the operations comprising:
receiving input data, wherein the input data includes, at least, an object query and object information, wherein the object query is generated by a user, and wherein the object information includes, at least, one leading object and at least one object attribute together with a rate range;
training, based on the received input data, a machine learning model to estimate rate elasticity, attraction value, and a dissimilarity index associated with the object query and the at least one object attribute;
generating one or more object bundles, wherein the one or more object bundles include the one leading object and one or more other object attributes associated with the leading product, and wherein the one or more object attributes include the at least one object attribute; and
outputting the one or more object bundles to the user, wherein the one or more object bundles include respective optimized rates based on the one or more object attributes.

16. The computer program product of claim 15, wherein the processor is further configured to perform operations comprising:
receiving prior user data, wherein the prior user data includes, at least a unique identifier for a prior user, procurement information that includes time series data associated with the procurement of the leading object together with the one or more object attributes.

17. The computer program product of claim 16, wherein the processor is further configured to perform operations comprising:
generating, based on the object query and the machine learning model, an attribute rate model, wherein the attribute rate model indicates respective rates for the one or more object attributes.

18. The computer program product of claim 17, wherein the attribute rate model captures dependencies across the one or more object attributes using one or more of rate elasticities, attraction values, and dissimilarity indices, and wherein the processor is further configured to perform operations comprising:
refining the attribute rate model by utilizing a fixed-point iteration.

19. The computer program product of claim 18, wherein the processor is further configured to perform operations comprising:
generating, based on the machine learning model and the attribute rate model, one or more procurement predictions, wherein the one or more procurement models are respectively associated with the one or more object bundles.

20. The computer program product of claim 19, wherein the processor is further configured to perform operations comprising:
prioritizing the one or more object bundles based on a predicted procurement propensity by the user.
